(19) United States
(12) Patent Application Publication
(10) Pub. No.: US 2011/0079966 A1
(43) Pub. Date: Apr. 7, 2011

(54) ASSEMBLY COMPRISING A SEAL INSERTED BETWEEN TWO COMPONENTS OF DIFFERENT MEAN THERMAL EXPANSION COEFFICIENT, ASSOCIATED SEAL, APPLICATION TO SEALING OF HTE ELECTROLYZERS AND SOFC FUEL CELLS

(75) Inventors: Gatien Fleury, Grenoble (FR); Patrick Le Gallo, Saint Appolinard (FR)

(73) Assignee: COMMISSARIAT A L'ENERGIE AUTOMIQUE ET AUX ENERGIES ALTERNATIVES, Paris (FR)

(21) Appl. No.: 12/999,474

(22) PCT Filed: Jun. 23, 2009
(86) PCT No.: PCT/EP2009/057764

§ 371 Date: Dec. 16, 2010

(30) Foreign Application Priority Data
Jun. 25, 2008 (FR) 08 54232

(51) Int. Cl. F16J 15/02

(52) U.S. Cl. 277/648

(57) ABSTRACT

The invention concerns an assembly typically operating at above 500° C., between two components of different mean thermal expansion coefficients, between which a seal is inserted having a coefficient which differs by a value of at least 1.10⁻⁶ K⁻¹ from the coefficient of at least one of the two components.

According to the invention:

below a threshold temperature, the seal undergoes orthogonal compression obtained by constant clamping of the two components towards each other,

above the threshold temperature, the seal undergoes orthogonal compression by clamping and radial compression obtained by the sliding of seal surfaces bearing upon at least one of the components until an end portion of the seal is placed under radial compression against the same component, this portion being free of any contact below the threshold temperature. The seal is designed not to reach its creep rupture point during a cycle of use of predetermined duration.

### TECHNICAL FIELD

The invention generally concerns the forming of a seal between two components of different mean thermal expansion coefficient, chosen for example from among metallic components and ceramic components.

It generally applies to ceramic-metal connections operating at high temperature.

It is advantageously applied to high temperature steam electrolyzers (usually and hereunder designated HTE) used for hydrogen production.

It can also be applied to fuel cells operating at high temperature i.e. Solid Oxide Fuel Cells usually and hereunder designated SOFC.

### PRIOR ART

HTE concerns electrochemical systems intended to produce hydrogen from the electrolysis of water at between 600° C. and 1000° C. They represent one of the most promising processes for producing hydrogen.

The applicant therefore envisages the rapid manufacture of electrolysers coupled with heat sources that do not generate greenhouse gases, notably of nuclear, geothermal or solar origin.

To arrive at competitive production costs, one option is to electrolyse water in vapour phase and at high temperature. For this technology, the management of gases and maintained sealing over time form one of the major barriers.

At envisaged temperatures, an electrochemical cell is used which chiefly comprises a three-layer stack in ceramic of which one drawback is the fragility thereof. This can limit the forces which can be applied to the seals. In addition, since electrolyte materials have low ion conduction properties at low temperature, it is consequently necessary to raise the operating temperature to above 600° C. to limit ohmic losses. This generates difficulties with respect to the resistance of metal materials, notably the bipolar plates and seals. While oxidation appears to be major the drawback at high temperatures for bipolar plates, the mechanical strength of the seals is even more penalizing.

Insufficient leak-tightness of the seals i.e. which would generate loss of fuel (and of end product) of more than 1% would not allow HTE or high temperature fuel cells (SOFC) to achieve a competitive energy yield compared with today's mature technologies.

The solutions of reference for the sealing of these systems use glass seals. However glass has poor thermal cycling properties.

Sealing solutions using metallic seals placed under compression which are currently commercially available, which would allow sufficient performance levels to be obtained, require the application of high clamping forces, typically of more than 20 N/seal cm.

Yet, as mentioned above, the cell used in fuel cells of SOFC type or for HTE contains fragile materials such as the ceramic electrolyte and porous electrodes. These fragile materials cannot withstand the high clamping forces indicated above.

Therefore, numerous seals with low compressive force have been recently developed. Some seals, at the development stage, are integrated into spacers separating the elementary cells in a fuel cell assembly.

Document U.S. Pat. No. 7,226,687 can be cited which discloses a stack of fuel cells in which the anode of one cell and the cathode of the adjacent cell are separated by metal separators acting as seals. Each separator is made using a stamping process and curling the edges. Each separator with curled edge only acts under axial compression. This document does not focus on the seal between two materials of different mean thermal expansion coefficient.

Therefore few sealing solutions are proposed at the present time for seals directly applicable to SOFCs and/or HTE and with low clamping force typically of less than 20 N/seal cm.

The objective of the invention is therefore to propose a new type of connection between two components of different mean thermal expansion coefficient whose leak-tightness is efficiently ensured at high temperature typically higher than 500° C., using a low clamping force, and which withstands the thermal cycles conducted in HTEs and/or SOFCs.

### DISCLOSURE OF THE INVENTION

For this purpose, the subject matter of the invention is an assembly between two components of different mean thermal expansion coefficient, comprising an element forming a seal inserted between the two components whose mean thermal expansion coefficient differs by a value of at least 1.10⁻⁶ K⁻¹ from that of at least one of the two components and whose continuous shape comprises planar surfaces separated from one another and at least one end portion located outside the portions formed between the surfaces.

According to the invention, the sealing of the assembly is obtained:

below a predetermined threshold temperature, by compressing the seal in a direction orthogonal to the components, obtained by constant clamping of the components towards each other which places part of the planar surfaces in fixed bearing upon one of the components and another part of the planar surfaces upon the other component, whilst leaving the end portion of the seal free of any contact,

above the threshold temperature, by orthogonal compression of the seal again obtained by clamping, and by compression of the seal in a direction radial to the components obtained by sliding of at least part of the planar surfaces bearing upon a component during temperature rise, and until the end portion is placed under radial compression by the same component.

The solution of the invention therefore comprises a combination of compression orthogonal to the components obtained by initial clamping, and radial compression obtained by sliding of the seal due to the difference in thermal expansion until the seal is placed under axial compression by the component(s).

Consideration must also be given to phenomena of creep and relaxation due to the viscoplastic properties of the materials.

Creep is a well-understood phenomenon and is a function of time. It occurs when a viscoplastic material is subjected to a constant force over time. The person skilled in the art therefore takes care to define a seal shape such that its yield point is never reached during thermal cycles over the period of use of the assembly.

Similarly, if the seal is worked at constant height, i.e. under a force varying over time (since the material relaxes), the choice of material and thickness is adapted so that relaxation of the material remains sufficiently low thereby maintaining sufficient contact force to ensure the desired sealing.

The table given in FIG. 1 is provided by UGINE and concerns AISI 430 or F17 ferritic steel. It shows the creep rupture strength (in MPa) of this material as a function of the temperature to which it is subjected and the number of hours of use. Therefore, under the invention, when the assembly is subjected to a cycle of use of more than 10,000 hours at a temperature of 600° C. (e.g. with stationary application of a HTE electrolyser), the rupture strength of a seal in F17 ferritic steel suitable for the invention is lower than 45 MPa.

To take these problems into account, it is possible to use commercial simulation software allowing the selection of materials and material thickness.

According to one advantageous embodiment, the seal has a mean thermal expansion coefficient which differs from that of one of the components by a value of between 0 and 10⁻⁶ K⁻¹ and a continuous shape comprising three planar surfaces separated from each other and an end portion located outside the portions formed between the surfaces, sealing being provided:

below the threshold temperature, by constant clamping, which places one of the three planar surfaces bearing upon the component having the coefficient differing the least from the coefficient of the seal, the two other planar surfaces upon the component having the coefficient differing the most from the coefficient of the seal, whilst leaving the end portion free of any contact,

above the threshold temperature, by orthogonal compression of the seal obtained by the same constant clamping which maintains the planar surface under fixed bearing upon the component with the least difference in coefficient, and by compression of the seal in a direction radial to the components obtained by sliding of the two other planar surfaces on the component with the greatest coefficient difference until the end portion is placed under radial compression by the same component.

According to one embodiment, the component having the mean thermal expansion coefficient which differs the least is a metallic component, and the component with the mean thermal expansion coefficient which differs the most is a ceramic component.

According to one variant, the metallic component and the seal may form a single block element. This notably allows the seal to be integrated directly in a structural part of a HTE stack or SOFC fuel cell, e.g. an interconnect or a collector in charge of distributing gases.

According to one advantageous configuration, the two components are planar substrates at least one thereof comprising an undercut in which a planar surface is housed that is joined to the end portion, the placing under radial compression of the latter being made against an edge of this undercut.

According to another preferred configuration, the placing under radial compression of the end portion is made against an edge of one of the substrates.

The invention also concerns a seal intended to be inserted in an assembly described in the foregoing, comprising at least one continuous shape comprising planar surfaces separated from each other and an end portion located outside the portions formed between the surfaces, the shape being obtained by a single stamping operation of sheet metal.

One embodiment of said seal may advantageously comprise two continuous shapes, each obtained by a single stamping operation of sheet metal and fixed together by welding or brazing at one of their planar surfaces.

According to one variant of embodiment, the two continuous shapes are substantially identical and fixed together head-to-tail so that the two end portions do not face one another. This variant of embodiment of the seal can be advantageous if the two components to be assembled have different mean thermal expansion coefficients α, each differing by at least 1.10⁻⁶ K⁻¹ from the coefficient of the seal, but only one of the components has a lower coefficient than the seal.

According to one variant of embodiment, the two continuous shapes are substantially identical and fixed together symmetrically relative to a plane defined by the common planar surface. This variant of embodiment of the seal may be advantageous if the two components to be assembled have different thermal expansion coefficients and both have lower coefficients than the seal, the difference being at least 10⁻⁶ K⁻¹.

The invention also concerns a seal intended to be inserted in an assembly described previously, whose continuous shape comprises a first part comprising planar surfaces separated from each other and obtained by a single stamping operation of sheet metal, and a second part comprising an end portion located outside the portions formed between the surfaces which is fixed to the first part by welding and/or brazing.

The sheet metal to be stamped to arrive at the shape of the seal may advantageously comprise ferritic steel or austenitic steel or a nickel alloy of Inconel 600 or Haynes 230 types.

For applications in which it is necessary to provide for electric insulation concomitant with leak-tightness, the metal sheet can be coated with an electrically insulating material. This coating can be formed by growing an oxide on the surface of the stamped sheet metal, or by usual layer depositing advantageously from an alumina-forming alloy. Preferably, the insulating layer can be obtained by thermal oxidation in air at 1,000° C. or higher, prior to forming by stamping. Consolidation annealing under similar conditions is recommended after stamping.

Additionally, to guarantee radial sealing even further, a layer of ductile material can advantageously be deposited, after stamping the sheet metal, on at least one end portion or on a contact area either with direct contact or on the coating of electrically insulating material. This may be a layer of silver of silver-containing compound and preferably comprising one of the following elements: Cu, Sn, Bi, Si, Co. This additional ductile layer may be applied by electrolytic deposit or serigraphy, these two depositing methods advantageously using a mask to allow precise location of this layer. It may have a thickness of between 1 and 10 μm.

According to one variant, the end portion is a simple curve directly joined to one of the planar surfaces.

If the size of the assembly is of the order of 100 mm, the sheet metal advantageously has a thickness of between 0.07 mm and 0.5 mm.

The height separating two planar surfaces corresponding to a draw depth of the sheet metal preferably lies between 0.2 mm and 1 mm.

The tilt angle of the segments between the planar surfaces may lie between 30 and 80°, and is advantageously between 30 and 55°.

Finally, the invention concerns a fuel cell operating at high temperature (SOFC) or a high temperature electrolyser (HTE) comprising an assembly mentioned above.

### BRIEF DESCRIPTION OF THE DRAWINGS

Other characteristics and advantages of the invention will be better understood on reading the detailed description given with reference to the following figures amongst which:

FIG. 1 is a table showing the value of the creep rupture strength for ferritic steel known commercially as F17, as a function of temperature and the number of hours of use;

FIG. 2 shows an assembly according to a first embodiment of the invention such as formed in a high temperature electrolyser HTE;

FIG. 2A illustrates an elementary electrolysis cell of ESC type (Electrolyte Supported cell), used in the HTE electrolyser of FIG. 2;

FIG. 3A is a cross-sectional view of the seal according to the invention before it is implanted in the assembly shown in FIGS. 2 and 3B;

FIG. 3B shows the assembly of FIG. 2 in detail;

FIG. 4 illustrates a variant of the assembly according to the first embodiment;

FIGS. 5 and 6 respectively illustrate an assembly according to a second and a third embodiment of the invention.

### DETAILED DESCRIPTION OF A PARTICULAR EMBODIMENT

The assembly of the invention here is formed in a high temperature electrolyser HTE. The proposed sealing solution uses a seal 5 such as schematically illustrated in FIGS. 3 to 6.

It is specified here that the orthogonal or axial direction X is the direction which extends along a section transverse to the electrolysis cell 1 and to the components 2, 3. The radial direction R is the direction which extends over a section parallel to the electrolysis cell 1 and to the components 2, 3.

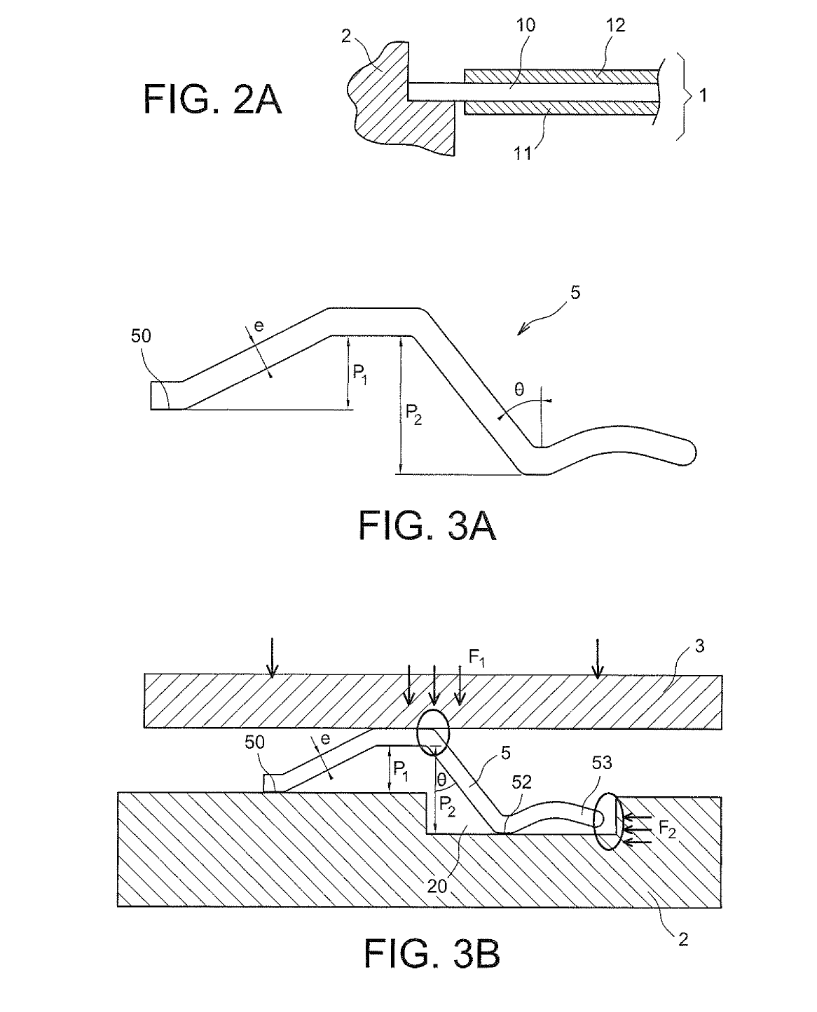

The high temperature electrolyser HTE in FIG. 2 comprises an electrolysis cell 1 supported by a ceramic support 2 and sandwiched between a cathode interconnect 3 and an anode interconnect 4 and a seal 5 according to the invention (FIG. 2). Only one part of the cell 1 is illustrated, the other part being symmetric relative to the axis represented on the right.

The electrolysis cell 1 such as illustrated comprises an electrolyte 10 directly supported by the ceramic support 2, and sandwiched between an anode 11 and a cathode 12 (FIG. 2A).

In the embodiment illustrated in FIGS. 2 and 2A, the cathode interconnect 3 is a planar substrate, and the material in which it is formed is a ferritic steel with a chromium content of about 22% whose commercial designation is Crofer 22APU (renowned for its resistance to corrosion in SOFC atmosphere). Its mean thermal expansion coefficient α3 is of the order of 12×10⁻⁶ K⁻¹.

By “mean thermal expansion coefficient” is meant the integral of the function representing the values of this coefficient as a function of temperature, between ambient temperature Tamb and functioning temperature Tfonc, divided by the difference between these two temperatures:

$$α = {\int }_{Tamb}^{Tfonc} \frac{f ( T ) d T}{Δ T}$$

As is more usual, a simple arithmetic mean between the two extreme values (α (Tfonc)−α (Tamb)) divided by the temperature difference Δ=Tfonc−Tamb is sufficient for proper dimensioning of the seal.

Other stainless steels or nickel-based alloys can also be envisaged.

The cell holder 2 is a planar substrate made in bulk yttria-stabilized zirconia. Its mean thermal expansion coefficient α2 is of the order of 10⁻⁶ K⁻¹ at ambient temperature.

The seal 5 according to the first embodiment in FIGS. 2, 3A and 3B has a continuous shape comprising three planar surfaces 50, 51, 52 separated from one another and an end portion 53 located outside the portions formed between the surfaces. The end portion 53 here is a simple curve directly joined to the planar surface 52. This continuous shape was obtained by a single stamping operation of sheet metal.

This sheet metal is ferritic steel of F17 type (AISI 430) or austenitic type (e.g. AISI 316 L) or a nickel-based alloy of Inconel 600 or Haynes 230 type. Their mean thermal expansion coefficients αj are respectively of the order of 11.10⁻⁶, 17.10⁻⁶, 15.10⁻⁶, 11.10⁻⁶ K⁻¹.

Additionally, the shape of the seal is designed so that it does not reach its creep rupture point during a cycle of use of the assembly, of predetermined duration. This predetermined duration is a function of the intended application for the HTE electrolyser: at least 5,000 hours for portable application, at least 50,000 hours for stationary application.

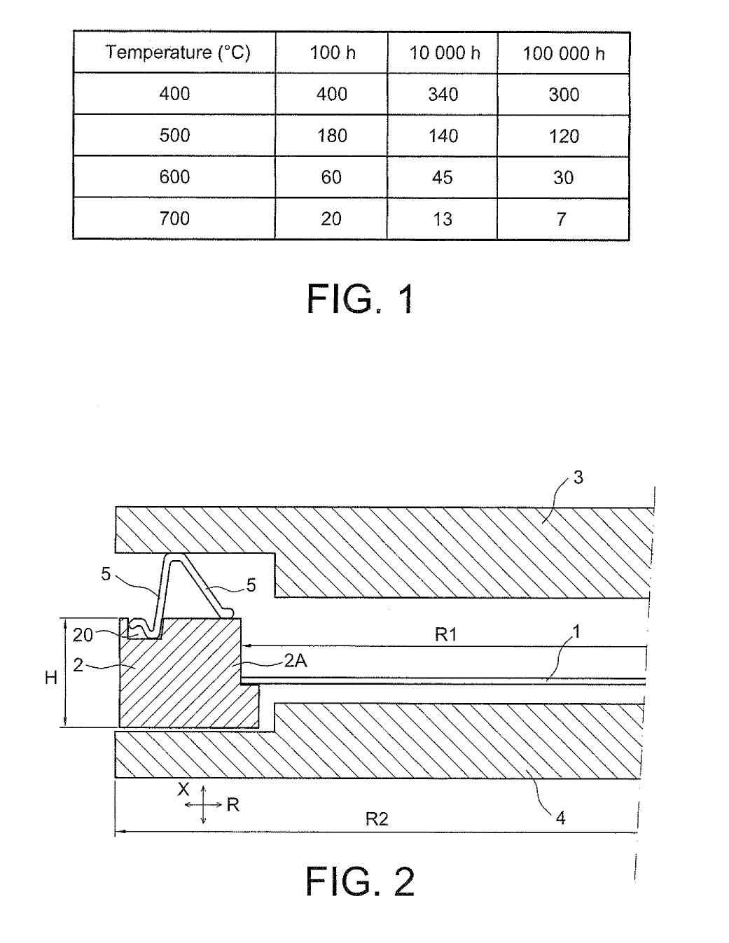

On the basis of knowledge of the creep rupture strength of the seal 5 in ferritic AISI 430 steel, in relation to temperature and the number of hours' use intended for the electrolyser (see the table in FIG. 1), it is possible to define the architecture of the seal 5.

In the embodiment shown in FIGS. 2 and 3A for a cell of diameter 120 mm, the seal 5, before its implanting in the assembly of the invention, has a mean thickness e of the order of 0.1 mm, the draw depth p1 separating the two planar parts is of the order of 0.3 mm, the draw depth p2 separating the two other planar parts is of the order 0.6 mm and the tilt angle θ of the segments joining the planar surfaces 50, 51 and 51, 52 is of the order of 45°.

In the embodiment shown in FIGS. 2, 3, the planar surface 52 and the end portion 53 are housed in an undercut 20 made in the cell holder 2.

Therefore, the assembly according to a first embodiment of the invention illustrated in FIGS. 2 and 3, forms the seal between the cell holder and the metallic interconnect 3 in the following manner.

1) Below a predetermined threshold temperature, the seal 5 is compressed in a direction X orthogonal to the components 2, 3 obtained by constant clamping of components 2, 3 towards one another. With this initial clamping, the planar surface 51 is placed under fixed bearing upon the metallic interconnect 3, and the planar surfaces 51, 52 upon the cell holder 2 whilst leaving the end portion 53 of the seal free of any contact (see FIG. 3 the free space between the end 53 and the vertical edge 200 of the undercut 20).

2) Above the threshold temperature, the seal 5 remains compressed in direction X still by clamping, and becomes compressed in the radial direction R to components 2, 3. More precisely, during the temperature rise, the planar surface 51 is held under fixed bearing upon the interconnect 3, whilst subsequent to the difference in thermal expansion between the cell holder 2 and the seal 5, the planar surfaces 50 and 52 slide on the cell holder until the end portion 53 is placed under radial compression by the vertical edge 200 of the undercut 20.

The threshold temperature is determined in relation to the radial dimensions of the assembly, the materials, their expansion coefficient and the operating temperature of the assembly.

In the figures, the arrows F1 indicate the clamping force, lower than 20N/cm of seal 5, between the cell holder 2 and the interconnect 3 contributing towards axial compression in direction X, and the arrows F2 indicate the radial compression exerted upon the seal 5 subsequent to the difference in thermal expansion between the seal 5 and the cell holder 2. Ellipses are also shown which indicate the areas in which the leak-tightness of the invention is set up during the rise in temperature.

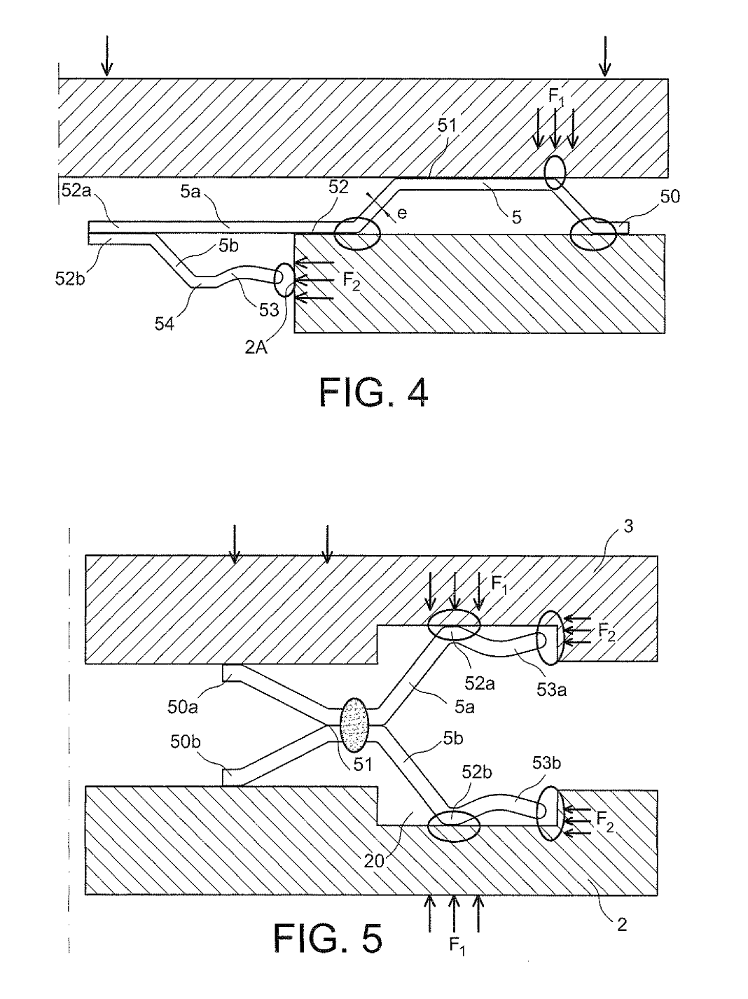

In the embodiment shown in FIG. 4, in which the seal 5 comprises two continuous shapes 5a, 5b each obtained by a single stamping operation of sheet metal and joined together by welding or brazing at one of their planar surfaces 52a, 52b. Welding may advantageously be laser welding. With this embodiment, it is notably possible to avoid forming a specific undercut in a solid part such as the cell holder 2. The placing under radial compression of the end portion 53 takes place here against a vertical edge 2A of the cell holder 2. This vertical edge 2A is the edge directed towards the inside of the electrolyser i.e. the edge with which the gases output from the cell 1 are likely to come into contact.

In this embodiment shown in FIG. 4, before implanting the seal 5 in the assembly of the invention, the mean thickness is of the order of 0.1 mm, the draw depth separating the surfaces 50, 52 from surface 51 is of the order of 0.3 mm, the common surface 52a, 52b is of the order of 0.5 mm, the draw depth separating the surface 52b from the intermediate surface 54 is of the order of 0.5 mm and the tilt angle θ of the segments joining the planar surfaces together is of the order of 45°.

The seal 5 of the embodiment shown in FIGS. 2, 3 and 3A can be used with the same architecture if the assembly is to be formed with a component 2 such that the difference in mean thermal expansion coefficient α2-αj is greater than 1.10⁻⁶ K⁻¹, the component having a coefficient α2 greater than that of the seal (FIG. 3A).

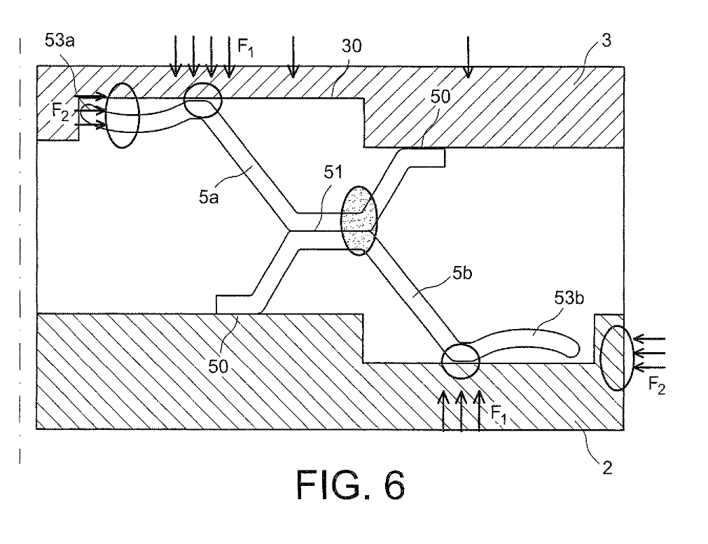

The embodiment in FIG. 6 corresponds to an assembly of two components 2, 3 in which the seal 5 has a mean thermal expansion coefficient αj whose difference with each of the coefficients α1 and α2 is greater by at least 1.10⁻⁶ K⁻¹. Here, the two continuous shapes 5a, 5b are substantially identical and are fixed together symmetrically relative to a plane P defined by the common planar surface 51a, 51b. Therefore an undercut 30 is also made in component 3. In this embodiment the sealing is therefore twofold, combining sealing through axial compression due to the clamping force and sealing through radial compression due to the difference in thermal expansion.

The embodiment in FIG. 7 corresponds to an assembly between two components 2, 3 in which the seal 5 has the same architecture as the architecture in FIG. 5. Here the seal 5 has a mean thermal expansion coefficient αj such that:

the difference αj−α2 is greater by at least 1.10⁻⁶ K⁻¹;

the difference α3−αj is greater by at least 1.10⁻⁶ K⁻¹. In other words, the component 3 has a mean thermal expansion coefficient that is greater than that of the seal. Here, the two continuous shapes 5a, 5b are substantially identical and fixed together head-to-tail so that the two end portions 53a, 53b do not face each other. In this embodiment shown in FIG. 7, sealing is again twofold through axial compression due to the clamping force and through radial compression due to the difference in thermal expansion between the seal 5 and each of components 2, 3, but compared with the embodiment in FIG. 6, the component 3 here expands more than the seal 5.

Other improvements can be envisaged without departing from the scope of the invention.

The high temperature assembly of the invention has been described with reference to the figures for sealing of the cathode compartment and to avoid losing the hydrogen produced in a HTE electrolyser. It can just as well be reproduced on the anode side thereby forming a seal on the oxygen side.

The seal 5 such as illustrated in the HTE shown in FIG. 2 is of general annular shape. The dimensions of said HTE are of the order of R1=60 mm, R2=70 mm and H=10 mm. It would be equally feasible to form a seal 5 of general rectangular or other shape with dimensions of the same or different magnitude.

The assembly of the invention is also particularly adapted to large-scale architectures of HTE electrolysers or SOFC fuel cells, in which the differences between expansion coefficients give rise to major deformations.

1-16. (canceled)

17. Assembly between two components of different mean thermal expansion coefficients α2, α3 comprising an element forming a seal inserted between the two components, whose mean thermal expansion coefficient αⱼ differs from that α₃ of one of the components having the least difference with the coefficient of the seal, the difference αⱼ-α₃ having a value of between 0 and 1.10⁻⁶ K⁻¹, the seal having a continuous shape comprising three planar surfaces separated from one another and an end portion located outside the portions formed between the surfaces, sealing being provided:
below the predetermined threshold temperature, by compression of the seal in a direction orthogonal (X) to the components obtained by constant clamping of the components towards each other, which places one of the three planar surfaces bearing upon the component with the coefficient α₃ having the least difference with that αⱼ of the seal, the two other planar surfaces upon the component with the coefficient having the greatest difference with that αⱼ of the seal, whilst leaving the end portion free of any contact,
above the threshold temperature, by orthogonal compression of the seal again obtained by the same constant clamping which maintains the planar surface in fixed bearing upon the component with the coefficient α₃ having least difference with that αⱼ of the seal, and by compression of the seal in a direction radial (R) to the components obtained by sliding of the two other planar surfaces on component with the coefficient α2 having the greatest difference with that αj of the seal, until the end portion is placed under radial compression by the same component.

18. The assembly according to claim 17, wherein the component of mean thermal expansion coefficient having least difference α3 is a metallic component and the component of mean thermal expansion coefficient having the greatest difference α2 is a ceramic component.

19. The assembly according to the claim 18, wherein the metallic component and the seal form a single-block element.

20. The assembly according to claim 17, wherein the two components are planar substrates, at least one thereof comprising an undercut in which a planar surface is housed joined to the end portion, the placing under radial compression of the latter occurring against an edge of this undercut.

21. The assembly according to claim 17, wherein the two components are planar substrates, the placing under radial compression of the end portion occurring against an edge of one of the substrates.

22. The assembly according to claim 17 comprising a seal having at least one continuous shape comprising planar surfaces separated from one another and an end portion located outside the portions formed between the surfaces, the shape being obtained by a single stamping operation of sheet metal.

23. The assembly according to claim 17 comprising a seal comprising two continuous shapes each obtained with a single stamping operation of sheet metal and joined together by welding or brazing at one of their planar surfaces.

24. The assembly according to claim 23 comprising a seal wherein the two continuous shapes are substantially identical and joined together head-to-tail so that the two end portions do not lie opposite one another.

25. The assembly according to claim 23 comprising a seal wherein the two continuous shapes are substantially identical and joined together symmetrically relative to a plane (P) defined by the common planar surface.

26. The assembly according to claim 17 comprising a seal whose continuous shape comprises a first part comprising planar surfaces separated from one another and obtained by a single stamping operation of sheet metal, and a second part comprising an end portion located outside the portions formed between the surfaces and fixed to the first part by welding or brazing.

27. The assembly according to claim 22 comprising a seal wherein the sheet metal comprises ferritic steel or austenitic steel or a nickel-based alloy of Inconel 600 or Haynes 230 type.

28. The assembly according to claim 22 comprising a seal wherein the sheet metal is coated with an electrically insulating material advantageously produced from an alumina-forming material.

29. The assembly according to claim 22 comprising a seal wherein a layer of ductile material is deposited, after stamping of the sheet metal, on at least one end portion or on a contact area, either by direct contact or on the coating of electrically insulating material.

30. The assembly according to claim 29, comprising a seal, wherein the ductile layer is a layer of silver of silver-containing compound and preferably comprising one of the following elements: Cu, Sn, Bi, Si, Co.

31. The assembly according to claim 17, comprising a seal, wherein the end portion is a simple curve directly joined to one of the planar surfaces.

32. Fuel cell operating at high temperature (SOFC) or high temperature electrolyser (HTE) comprising an assembly according to claim 17.
